(19) United States
(12) Patent Application Publication
(10) Pub. No.: US 2009/0241471 A1
(43) Pub. Date: Oct. 1, 2009

(54) PROCESS FOR PRODUCING POWDER WAFERS FOR EYE SHADOWS, FACE POWDER, MAKE-UP ARTICLES, BLUSHER, ETC. WITH A MOSAIC EFFECT ACHIEVED BY COMPACTING VARIOUSLY COLOURED PELLETS

(75) Inventors: Marco Lazzarini, Milano (IT); Francesca Iacovacci, Cavenago Brianza (IT)

Correspondence Address: SEED INTELLECTUAL PROPERTY LAW GROUP PLLC, 701 FIFTH AVE, SUITE 5400, SEATTLE, WA, 98104, US

(73) Assignee: INTERCOS S.p.A., Milano (IT)

(21) Appl. No.: 12/414,440

(22) Filed: Mar. 30, 2009

(30) Foreign Application Priority Data
Mar. 31, 2008 (IT) MI2008A000552

(51) Int. Cl. B65B 1/24; B05D 7/00

(52) U.S. Cl. 53/436; 53/435; 53/474; 427/214; 427/218

(57) ABSTRACT

There is described a process for producing multicolored solid powder wafers for use in solid beauty products, wherein the solid powder wafers so produced have a mosaic effect.

### CROSS-REFERENCE TO RELATED APPLICATIONS

This application claims the priority benefit under 35 U.S.C. 119 of Italian Patent Application No. MI2008A000552, filed Mar. 31, 2008, which is incorporated in full by reference herein.

### FIELD OF THE INVENTION

The present invention relates to a process for producing solid (pressed) powder wafers for solid beauty products such as, but not limited to, eye shadow, face powder, blusher, and other make-up articles, wherein the solid powder wafers so produced have a mosaic effect achieved by the compaction of variously colored pellets of powder therein.

### BACKGROUND OF THE INVENTION

Solid beauty products, in particular pressed powder beauty products, are generally marketed in specific packages which comprise one or more powder wafers of uniform color placed in a differentiated manner, which in turn are individually accommodated in cups made of metal or other material.

The aesthetic appearance of such a solid beauty product plays a very important role in the marketing of the beauty product, especially if “amazing” color effects are successfully produced, particularly effects which are generated by individual colors which in turn occupy various shapes enclosed in a single package.

Several processes are known by which “multicolor” solid beauty products are obtained, which, in addition to have a primarily aesthetic purpose, are aimed at allowing consumers of the beauty product to obtain a make-up having color shades derived by mixing the colored powders existing in the beauty product once the beauty product has been applied by means of a specific accessory.

Some known processes of obtaining “multicolor” solid beauty products include matching one or more colored powders in one product, wherein the colored powders are optionally separated from one another by diaphragms which prevent the various colors from getting mixed.

### BRIEF SUMMARY OF THE INVENTION

It is therefore an object of the invention to provide a different process as compared to those of the known art, which will allow the amalgamation of several colored powders having different geometrical shapes within a single package so as to create an amazing aesthetic effect. The process comprises the steps of forming a base pellet from a first powder beauty product having a first color and coating the base pellet with a second powder beauty product having a second color, repeating the coating process with additional powder beauty products as desired, filling a container with the coated pellets, pre-compacting the coated pellets within the container, cutting the pre-compacted coated pellets so as to highlight the color difference between the base pellet and the coatings thereon and compacting the cut pre-compacted coated pellets so as to form a solid (pressed) powder wafer for use in a beauty product wherein the solid powder wafer has a mosaic color effect.

### BRIEF DESCRIPTION OF THE DRAWINGS

FIGS. 1-8 are schematic drawings of the various steps of the process according to the invention.

FIG. 9 shows a plane view of a powder wafer of a beauty product which may be obtained by the process according to the invention.

### DETAILED DESCRIPTION OF THE INVENTION

The present invention is directed to a process for producing solid powder wafers for solid beauty products wherein the solid (pressed) powder wafers have a mosaic effect achieved by the compaction of variously colored pellets of powder therein.

Accordingly, the process comprises the following sequential steps:

a) placing an amount of a first powder beauty product having a first color into a rotating drum mixer and spraying said first powder beauty product with an agglomerating liquid until base pellets comprising said first beauty product are formed;

b) sprinkling said base pellets in said rotating drum mixer with an amount of a second powder beauty product having a second color to form a mixture of said base pellets and said second powder beauty product and spraying said mixture with said agglomerating liquid so as to obtain coated pellets comprising said base pellets and a coating comprising said second powder beauty product;

c) optionally repeating step b) one or more times with one or more additional powder beauty product(s) having a same or a different color as the first or second powder beauty product to obtain further coated pellets;

d) filling a container with a plurality of said coated pellets;

e) pre-compacting said plurality of said coated pellets in said container to form a pre-compacted product;

f) cutting said pre-compacted product to highlight the color difference between said base pellets and said coatings therein to form a cut pre-compacted product;

g) compacting said cut pre-compacted product to form a multicolored solid powder wafer comprised of said base pellets and said coatings.

The multicolored solid powder wafer so obtained offers amazing color effects, particularly a mosaic effect, when used as a solid beauty product. Such color effects draw the attention of the consumer, inducing the consumer to purchase the beauty product.

In one embodiment, the powder beauty products used in the process have the same color. In another embodiment, the powder beauty products used in the process have different colors.

The various steps of the process according to the invention and the obtained results will be apparent from the following detailed description of a practical embodiment of the process itself, with reference to the accompanying figures.

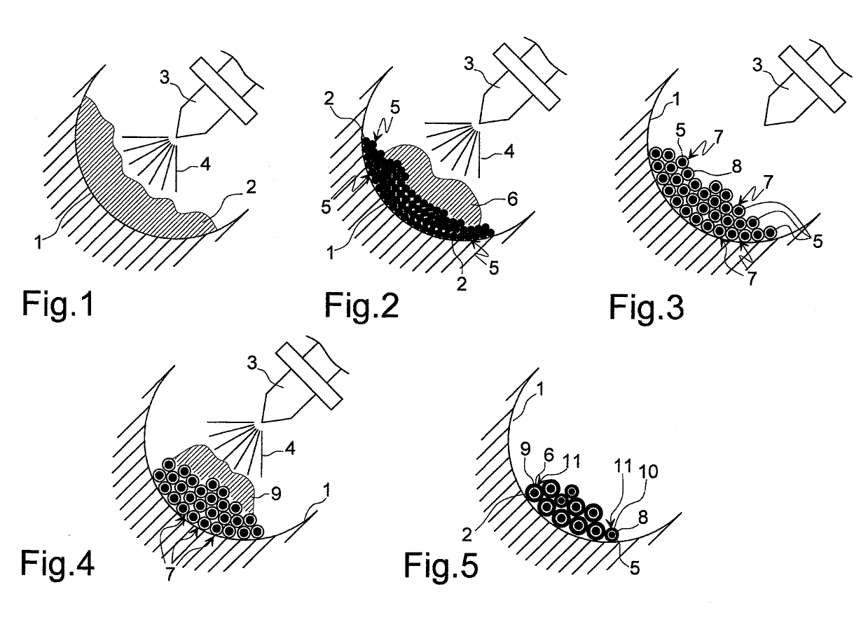

FIG. 1 shows a rotating drum mixer 1 within which an amount of a first powder beauty product 2 having a first color is placed. The first powder beauty product is then sprayed with an agglomerating liquid product 4 by means of a vaporizer 3.

The agglomerating liquid may comprise 100% water or a mixture of water and various raw materials, including, but not limited to, surfactants, emulsifiers or other products known to one skilled in the art, which may be used to promote the formation of base pellets 5 (FIG. 2) from the powder beauty product 2 by means of the rotation of the drum mixer 1.

FIG. 2 shows the drum mixer 1 containing base pellets 5 which are sprinkled with a second powder beauty product 6 having a second color to form a mixture. The mixture is then sprayed with the agglomerating liquid product 4 with the aid of the vaporizer 3 so as to coat base pellets 5 with a layer of second powder beauty product having a second color, generally different as compared to the color of the base pellet. Preferably the agglomerating liquid product 4 in this step is the same agglomerating liquid product used in the previous step. Due to the rotation of the drum mixer 1, coated pellets 7 are thus formed comprising the base pellets 5 having a first color and a coating layer 8 comprising the second power beauty product having a second color, generally different from the color of the first powder beauty product, as shown in FIG. 3.

The size of individual base pellets 5, coating layers 8 and coated pellets 7 may vary much depending on the needs.

FIG. 4 shows rotating drum mixer 1 again, in which coated pellets 7 are sprinkled with a third powder beauty product 9, preferably having a different color as compared to the previous two powder beauty products, in order to form a further coating layer 10.

The coating of coated pellets 7 with this further powder beauty product 9 occurs by employing vaporizer 3 which sprays the product with the agglomerating liquid product 4, as previously disclosed.

FIG. 5 shows the thus obtained pellets, indicated by numeral 11 as a whole, comprising base pellet 5 of powder beauty product 2 and two external coatings 8, 10 of powder beauty products 6, 9, respectively.

The number of coating layers formed by the process of the invention may also be higher than three and exclusively depends on the size and colors of the coated pellets to be obtained.

FIG. 6 shows a container or cup 12 which contains a plurality of pellets 11 prior to being subjected to the pre-compacting treatment by means of a presser 13.

FIG. 7 shows pre-compacted product 14 which is cut by a blade 15 so that shape and color differences within the pre-compacted product 14 may be highlighted and so that the final size (e.g., height) of the desired solid beauty product is achieved.

FIG. 8 shows container 12 containing a solid powder wafer of the invention in a beauty product 16 after the final compacting treatment of the cut pre-compacted product 14 by presser 13 forms a solid powder wafer of the invention within container 12.

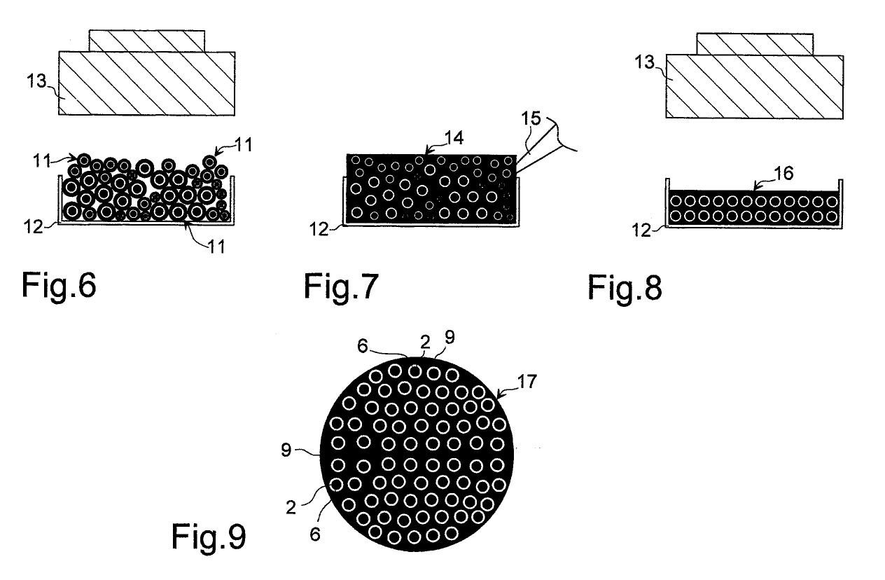

The result of the described process may be seen in FIG. 9, where a solid powder wafer 17 having a mosaic effect is shown, wherein the solid powder wafer comprises pellet-shaped bodies of first beauty powder product 2 with rounded coatings of second powder beauty product 6 and filling parts of powder beauty product 9.

The above description of an illustrated embodiment, including what is described in the Abstract, is not intended to be exhaustive or to limit the embodiment to the precise form disclosed. Although a specific embodiment is described herein for illustrative purposes, various equivalent modifications can be made without departing from the spirit and scope of the disclosure, as will be recognized by those skilled in the relevant art. The teachings provided herein of the embodiment can be applied to other processes, not necessarily the process generally described above.

These and other changes can be made to the embodiment in light of the above-detailed description. In general, in the following claims, the terms used should not be construed to limit the claims to the specific embodiment disclosed in the specification and the claims, but should be construed to include all possible embodiments along with the full scope of equivalents to which such claims are entitled. Accordingly, the claims are not limited by the disclosure.

What is claimed is:

1. A process for producing a multicolored solid powder wafer for a solid beauty product comprising the following steps in sequence:
a) placing an amount of a first powder beauty product having a first color into a rotating drum mixer and spraying said first powder beauty product with an agglomerating liquid until base pellets comprising said first beauty product are formed;
b) sprinkling said base pellets in said rotating drum mixer with an amount of a second powder beauty product having a second color to form a mixture of said base pellets and said second powder beauty product and spraying said mixture with said agglomerating liquid so as to obtain coated pellets comprising said base pellets and a coating comprising said second powder beauty product;
c) optionally repeating step b) one or more times with one or more additional powder beauty product(s) having the same or a different color as the first or second powder beauty product to obtain further coated pellets;
d) filling a container with a plurality of said coated pellets;
e) pre-compacting said plurality of said coated pellets in said container to form a pre-compacted product;
f) cutting said pre-compacted product to highlight the color difference between said base pellets and said coatings therein;
g) compacting said cut pre-compacted product to form a multicolored solid powder wafer comprised of said base pellets and said coatings.

2. The process of claim 1 wherein said powder beauty products have different colors.

3. The process of claim 1 wherein said powder beauty products have the same color.
